(19) United States
(12) Patent Application Publication
(10) Pub. No.: US 2025/0021841 A1
(43) Pub. Date: Jan. 16, 2025

(54) SAMPLE DETERMINING METHOD AND APPARATUS, AND DEVICE

(71) Applicant: VIVO MOBILE COMMUNICATION CO., LTD., Dongguan (CN)

(72) Inventor: Tong ZHOU, Dongguan (CN)

(73) Assignee: VIVO MOBILE COMMUNICATION CO., LTD., Dongguan (CN)

(21) Appl. No.: 18/900,864

(22) Filed: Sep. 29, 2024

Related U.S. Application Data
(63) Continuation of application No. PCT/CN2023/085459, filed on Mar. 31, 2023.

(30) Foreign Application Priority Data
Apr. 2, 2022 (CN) 202210350467.3

(51) Int. Cl. G06N 5/04

(52) U.S. Cl. CPC G06N 5/04

(57) ABSTRACT

This application discloses a sample determining method and apparatus, and a device. The sample determining method includes: receiving, by a first device, first information sent by a target device; and determining, by the first device based on an inference result of a target inference model and the time-varying parameter information, a training sample used for training the target inference model. The first information includes time-varying parameter information and Artificial Intelligence (AI) model attribute information. The time-varying parameter information is used for indicating randomness of a communication behavior. The target inference model is an inference model corresponding to the AI model attribute information.

### CROSS-REFERENCE TO RELATED APPLICATIONS

This application is a continuation of International Application No. PCT/CN 2023/085459, filed on Mar. 31, 2023, which claims priority to Chinese Patent Application No. 202210350467.3 filed on Apr. 2, 2022. The entire contents of each of the above-referenced applications are expressly incorporated herein by reference.

### TECHNICAL FIELD

This application relates to the field of communication technologies, and in particular, to a sample determining method and apparatus, and a device.

### BACKGROUND

The combination of artificial intelligence (Artificial Intelligence, AI) and wireless mobile communication can better improve communication quality, for example, AI-based channel quality compression, AI-based beam management, and AI-based positioning at a physical layer. Using beam management as an example, in millimeter wave wireless communication, a plurality of analog beams are configured in communication receiver and transmitter (for example, a base station and a terminal). For the same terminal, channel quality measured in different transmit and receive analog beams varies. How to quickly and accurately select a transmit and receive beam group with highest channel quality from all possible analog transmit and receive beam combinations is critical to transmission quality. After an AI neural network model is introduced, the terminal may effectively predict, based on the AI neural network model, analog transmit and receive beams with highest channel quality, and report the analog beams to a network side, so that better transmission quality can be obtained.

Reinforcement learning is a method for training an AI neural network model. Reinforcement learning training acts based on an environment and uses an inference result for training, so that an expected benefit can be maximized. Currently, limited by computing capabilities of devices, an inference function and a training function are separately deployed on different devices, and therefore, the reinforcement learning training of an AI neural network model is not supported.

### SUMMARY

Embodiments of this application provide a sample determining method and apparatus, and a device.

According to a first aspect, a sample determining method is provided, including:
receiving, by a first device, first information sent by a target device, where the first information includes time-varying parameter information and artificial intelligence AI model attribute information, and the time-varying parameter information is used for indicating randomness of a communication behavior; and
determining, by the first device based on an inference result of a target inference model and the time-varying parameter information, a training sample used for training the target inference model, where the target inference model is an inference model corresponding to the AI model attribute information.

According to a second aspect, a sample determining method is provided, including:
sending, by a target device, first information to a first device, where the first information includes time-varying parameter information and AI model attribute information, and the time-varying parameter information is used for indicating randomness of a communication behavior, where
the time-varying parameter information and the AI model attribute information are used for determining a training sample, the training sample is used for training a target inference model, and the target inference model is an inference model corresponding to the AI model attribute information.

According to a third aspect, a sample determining apparatus is provided, where a first device includes the sample determining apparatus, and the apparatus includes:
a receiving module, configured to receive first information sent by a target device, where the first information includes time-varying parameter information and artificial intelligence AI model attribute information, and the time-varying parameter information is used for indicating randomness of a communication behavior; and
a first determining module, configured to determine, based on an inference result of a target inference model and the time-varying parameter information, a training sample used for training the target inference model, where the target inference model is an inference model corresponding to the AI model attribute information.

According to a fourth aspect, a sample determining apparatus is provided, where a target device includes the sample determining apparatus, and the apparatus includes:
a sending module, configured to send first information to a first device, where the first information includes time-varying parameter information and AI model attribute information, and the time-varying parameter information is used for indicating randomness of a communication behavior, where
the time-varying parameter information and the AI model attribute information are used for determining a training sample, the training sample is used for training a target inference model, and the target inference model is an inference model corresponding to the AI model attribute information.

According to a fifth aspect, an electronic device is provided, where the electronic device is a first device and includes a processor and a memory, where the memory stores a program or an instruction runnable on the processor, and the program or the instruction, when executed by the processor, implements the steps of the method according to the first aspect.

According to a sixth aspect, an electronic device is provided, where the electronic device is a first device and includes a processor and a communication interface, where the communication interface is configured to receive first information sent by a target device, the first information includes time-varying parameter information and artificial intelligence AI model attribute information, and the time-varying parameter information is used for indicating randomness of a communication behavior; and the processor is configured to determine, based on an inference result of a target inference model and the time-varying parameter information, a training sample used for training the target inference model, where the target inference model is an inference model corresponding to the AI model attribute information.

According to a seventh aspect, an electronic device is provided, where the electronic device is a target device and includes a processor and a memory, where the memory stores a program or an instruction runnable on the processor, and the program or the instruction, when executed by the processor, implements the steps of the method according to the second aspect.

According to an eighth aspect, an electronic device is provided, where the electronic device is a target device and includes a processor and a communication interface, where the communication interface is configured to send first information to a first device, where the first information includes time-varying parameter information and AI model attribute information, and the time-varying parameter information is used for indicating randomness of a communication behavior, where the time-varying parameter information and the AI model attribute information are used for determining a training sample, the training sample is used for training a target inference model, and the target inference model is an inference model corresponding to the AI model attribute information.

According to a ninth aspect, a sample determining system is provided, including: a first device and a target device, where the first device may be configured to perform the steps of the sample determining method according to the first aspect, and the target device may be configured to perform the steps of the sample determining method according to the second aspect.

According to a tenth aspect, a readable storage medium is provided, where the readable storage medium stores a program or an instruction, and the program or the instruction, when executed by a processor, implements the steps of the method according to the first aspect, or the steps of the method according to the second aspect.

According to an eleventh aspect, a chip is provided, where the chip includes a processor and a communication interface, the communication interface is coupled to the processor, and the processor is configured to run a program or an instruction to implement the method according to the first aspect or the method according to the second aspect.

According to a twelfth aspect, a computer program/program product is provided, where the computer program/program product is stored in a storage medium, and the computer program/program product is executed by at least one processor to implement the steps of the sample determining method according to the first aspect, or the computer program/program product is executed by at least one processor to implement the steps of the sample determining method according to the second aspect.

In the embodiments of this application, a first device receives first information sent by a target device, where the first information includes time-varying parameter information and artificial intelligence AI model attribute information, and the time-varying parameter information is used for indicating randomness of a communication behavior. The first device determines, based on an inference result of a target inference model and the time-varying parameter information, a training sample used for training the target inference model, where the target inference model is an inference model corresponding to the AI model attribute information. In this way, the time-varying parameter information and the AI model attribute information are obtained through the interaction between the first device and the target device, and the training sample used for training the target inference model is obtained on the first device. In this way, the target inference model can be trained by using a network environment of the first device, so that reinforcement learning training of the target inference model can be implemented.

### BRIEF DESCRIPTION OF THE DRAWINGS

FIG. 1 is a block diagram of a wireless communication system to which an embodiment of this application is applicable;

FIG. 2 is a first flowchart of a sample determining method according to an embodiment of this application;

FIG. 3 is a second flowchart of a sample determining method according to an embodiment of this application;

FIG. 4 is a first structural diagram of a sample determining apparatus according to an embodiment of this application;

FIG. 5 is a second structural diagram of a sample determining apparatus according to an embodiment of this application;

FIG. 6 is a structural diagram of a communication device according to an embodiment of this application;

FIG. 7 is a schematic structural diagram of a terminal according to an embodiment of this application; and

FIG. 8 is a schematic structural diagram of a network side device according to an embodiment of this application.

### DETAILED DESCRIPTION

The technical solutions in embodiments of this application are clearly described in the following with reference to the accompanying drawings in the embodiments of this application. Apparently, the described embodiments are merely some rather than all of the embodiments of this application. All other embodiments obtained by a person of ordinary skill in the art based on the embodiments of this application fall within the protection scope of this application.

The terms “first”, “second”, and so on in this specification and claims of this application are intended to distinguish between similar objects but are not intended to describe a specific order or sequence. It should be understood that the terms used in such a way are interchangeable in proper circumstances, so that the embodiments of this application can be implemented in other sequences than the sequence illustrated or described herein. In addition, the objects distinguished by “first” and “second” are usually of one type, and there is no limitation on quantities of the objects. For example, there may be one or more first objects. In addition, “and/or” in this specification and the claims indicate at least one of the connected objects, and the character “/” usually indicates an “or” relationship between the associated objects.

It should be noted that, the technologies described in the embodiments of this application are not limited to a Long Term Evolution (LTE)/LTE-Advanced (LTE-A) system, and can be further used in other wireless communication systems, such as Code Division Multiple Address (CDMA), Time Division Multiple Access (TDMA), Frequency Division Multiple Access (FDMA), orthogonal frequency division multiple access (OFDMA), Single-carrier Frequency-Division Multiple Access (SC-FDMA), and other systems. The terms “system” and “network” in the embodiments of this application are often used interchangeably, and the described technologies can be used not only for the above-mentioned systems and radio technologies, but also for other systems and radio technologies. The following description describes a New Radio (NR) system for exemplary purposes, and uses NR terms in most of the following descriptions, but these technologies are also applicable to applications other than the NR system application, such as a 6th Generation (6G) communication system.

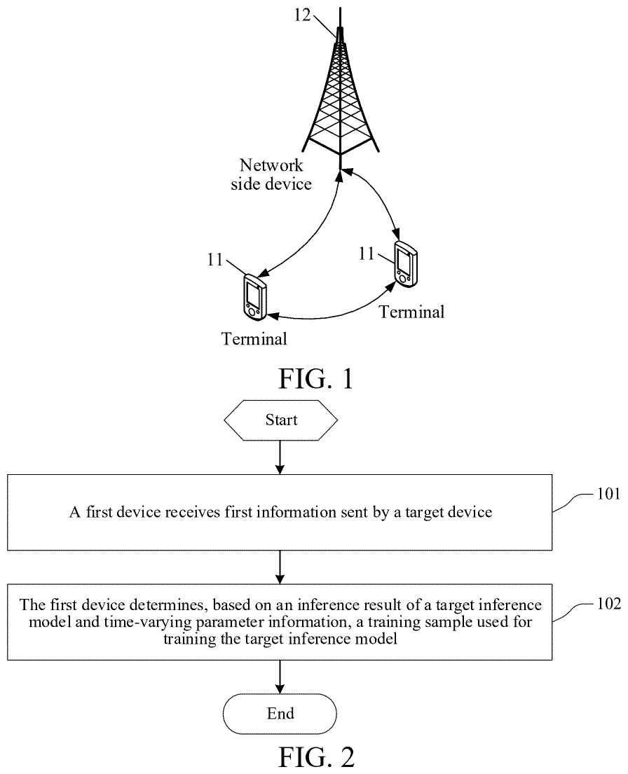

FIG. 1 is a block diagram of a wireless communication system to which an embodiment of this application is applicable. The wireless communication system includes a terminal 11 and a network side device 12. The terminal 11 may be a mobile phone, a tablet personal computer, a laptop computer or referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a Vehicle User Equipment (VUE), a Pedestrian User Equipment (PUE), a smart home (a home device having a wireless communication function, such as a refrigerator, a television, a washing machine, or furniture), a game console, a Personal Computer (PC), a teller machine, a self-service machine, and other terminal-side devices. The wearable device includes a smartwatch, a smart band, a smart headphone, smart glasses, smart jewelry (a smart bracelet, a smart wrist-band, a smart ring, a smart necklace, a smart anklet, a smart ankle chain, and the like), a smart wrist strap, smart clothes, and the like. It should be noted that a specific type of the terminal 11 is not limited in this embodiment of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a WiFi node, or the like. The base station may be referred to as a Node B, an evolved Node B (eNB), an access point, a Base Transceiver Station (BTS), a radio base station, a radio transceiver, a Basic Service Set (BSS), an Extended Service Set (ESS), a home node B, a home evolved node B, a Transmitting Receiving Point (TRP), or some other suitable term in the art. As long as the same technical effect is achieved, the base station is not limited to a specific technical term. It should be noted that in this embodiment of this application, only a base station in an NR system is used as an example for description, and a specific type of the base station is not limited. The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), or the like. It should be noted that in this embodiment of this application, only a core network device in an NR system is used as an example for description, and a specific type of the core network device is not limited.

A sample determining method and apparatus, and a device provided in the embodiments of this application are described in detail below with reference to the accompanying drawings through some embodiments and application scenarios thereof.

FIG. 2 is a flowchart of a sample determining method according to an embodiment of this application. As shown in FIG. 2, the sample determining method includes the following steps:

Step 101: A first device receives first information sent by a target device, where the first information includes time-varying parameter information and artificial intelligence AI model attribute information, and the time-varying parameter information is used for indicating randomness of a communication behavior.

The time-varying parameter information may include a time-varying greedy parameter, or the time-varying parameter information may include a first boundary parameter, a second boundary parameter, and a training process parameter. The first boundary parameter is used for indicating a start boundary and an end boundary of the time-varying greedy parameter. The second boundary parameter is used for indicating start information and end information of a time-varying greedy strategy enabling training process; and so on. Using an example in which the communication behavior is represented by an action, the time-varying parameter information may be used for indicating randomness of the action.

In addition, the first device may be a terminal, a base station, a network management system (e.g. Operation Administration and Maintenance (OAM)), or a Self-Organizing Networks (SON), or a core network element (for example, a Network Data Analytics Function (NWDAF)), or a newly defined network element responsible for decision-making), network management, or the like. The target device may be a base station, a SON, an OAM, a core network element (for example, an NWDAF or a newly defined network element responsible for decision-making), network management, or the like.

In an implementation, the target device includes a second device. The first device receives first information sent by the second device, where the first information includes time-varying parameter information and AI model attribute information, and the time-varying parameter information includes a time-varying greedy parameter. Alternatively, the target device includes a second device and a third device. The first device receives the first boundary parameter and the second boundary parameter that are sent by the third device. The first device receives the training process parameter and the AI model attribute information that are sent by the second device. The first device can determine the time-varying greedy parameter based on the first boundary parameter, the second boundary parameter, and the training process parameter.

It should be noted that before sending the first information to the first device, the second device may receive second information from the third device to determine a training configuration. The second information may include hyperparameter configuration information and basic model information. The hyperparameter configuration information may include greedy coefficient configuration information and other configuration information. The greedy coefficient configuration information may include the start boundary and the end boundary of the time-varying greedy parameter, and the start information and the end information of the time-varying greedy strategy enabling training process.

Step 102: The first device determines, based on an inference result of a target inference model and the time-varying parameter information, a training sample used for training the target inference model, where the target inference model is an inference model corresponding to the AI model attribute information.

The inference result may be a result obtained by the first device through inference by using the target inference model. The AI model attribute information may be used for describing the target inference model. The first device may determine the target inference model through the AI model attribute information. For example, the AI model attribute information may include model attribute information used for describing the target inference model, such as a model structure of the target inference model and a model parameter of the target inference model.

In an implementation, the first device may determine a target communication behavior based on the inference result of the target inference model and the time-varying parameter information. The training sample includes the target communication behavior. The target communication behavior may be represented by an action. For example, the target communication behavior may be a first action. Determining the first action can enable Deep Q Network (DQN) reinforcement learning training. During the DQN training, randomness of actions may be determined by a time-varying greedy parameter (e.g. epsilon greedy).

In addition, after the first device determines the training sample, the first device may send the training sample to the target device. In this way, a training sample used for training the target inference model can be obtained on the first device, and the target inference model is trained on the target device by using the obtained training sample.

In an implementation, the first device may be a terminal, and the target device may be a network side device. In the current network, limited by computing capabilities, most terminals can support only inference rather than online training. For a scenario in which the terminal makes inference through an AI inference model and the network side device performs model training, that is, in a case that an inference device and a training device are separated, time-varying parameter information and AI model attribute information are obtained through the interaction between the terminal and the network side device, so that reinforcement learning of the AI inference model can be supported in the case that the inference device and the training device are separated.

It should be noted that in this embodiment of this application, the time-varying parameter information and the AI model attribute information are obtained through the interaction between the first device and the target device, so that a training process of reinforcement learning can be supported in a case that an inference device and a training device are separated. The first device may be the inference device, the target device may include a second device, and the second device may be the training device. In this way, the inference device receives the time-varying parameter information and the AI model attribute information from the training device, and determines, based on a model inference result and the time-varying parameter information, a training sample used for training the target inference model, so that a reinforcement learning training process in a scenario in which the inference device and the training device are separated can be supported.

In the embodiments of this application, a first device receives first information sent by a target device, where the first information includes time-varying parameter information and artificial intelligence AI model attribute information, and the time-varying parameter information is used for indicating randomness of a communication behavior. The first device determines, based on a model inference result of a target inference model and the time-varying parameter information, a training sample used for training the target inference model, where the target inference model is an inference model corresponding to the AI model attribute information. In this way, the time-varying parameter information and the AI model attribute information are obtained through the interaction between the first device and the target device, and the training sample used for training the target inference model is obtained on the first device. In this way, the target inference model can be trained by using a network environment of the first device, so that reinforcement learning training of the target inference model can be implemented.

In some embodiments, the time-varying parameter information includes a time-varying greedy parameter.

The target device may include a second device. The second device may be configured for AI training. The first device may receive the time-varying greedy parameter and the AI model attribute information sent by the second device, and determine, based on the model inference result of the target inference model and the time-varying greedy parameter, the training sample used for training the target inference model.

In this implementation, the time-varying parameter information includes a time-varying greedy parameter, so that the first device can determine, based on the model inference result of the target inference model and the time-varying greedy parameter, the training sample used for training the target inference model.

In some embodiments, the time-varying parameter information includes a first boundary parameter, a second boundary parameter, and a training process parameter. The first boundary parameter is used for indicating a start boundary and an end boundary of a time-varying greedy parameter. The second boundary parameter is used for indicating start information and end information of a time-varying greedy strategy enabling training process.

The training process may be represented by a training step or by an episode. One episode includes a plurality of training steps. The first boundary parameter may include a start boundary and an end boundary of the time-varying greedy parameter. The second boundary parameter may include a start and an end of a time-varying greedy strategy enabling training process. For example, the start of the time-varying greedy strategy enabling training process may be a start step of a training process when a time-varying greedy strategy is enabled. The end of the time-varying greedy strategy enabling training process may be an end step of the training process when the time-varying greedy strategy is enabled. The training process parameter may be used for indicating a pace of the training process. For example, the training process parameter may be a real-time training step.

In addition, the first boundary parameter and the second boundary parameter may be sent by a third device, and the training process parameter may be sent by the second device. Alternatively, the first boundary parameter, the second boundary parameter, and the training process parameter may be sent by a same device. This is not limited in this embodiment. The first boundary parameter and the second boundary parameter may be invariant parameters. The training process parameter may be a time-varying parameter.

In this implementation, the first device can obtain the time-varying greedy parameter through the first boundary parameter, the second boundary parameter, and the training process parameter, so that the training sample used for training the target inference model can be determined based on the model inference operation result of the target inference model and the time-varying greedy parameter. In this way, reinforcement learning of the target inference model can be supported.

In some embodiments, the target device includes a second device and a third device, and the receiving, by a first device, first information sent by a target device includes:
receiving, by the first device, the first boundary parameter and the second boundary parameter sent by the third device; and
receiving, by the first device, the training process parameter and the AI model attribute information sent by the second device.

In an implementation, the first device may determine a target communication behavior based on the model inference operation result of the target inference model, the first boundary parameter, the second boundary parameter, the training process parameter, and the AI model attribute information. The training sample includes the target communication behavior.

In an implementation, the first device may receive the first boundary parameter and the second boundary parameter that are sent by the third device with a first frequency. The first device may receive the training process parameter and the AI model attribute information that are sent by the second device with a second frequency. The first frequency and the second frequency may be different.

It should be noted that the first device may be configured for AI model inference, model inference result execution, and model inference impact observation. The second device may be configured for AI model training, for example, for management of real-time training parameters. The second device may be a base station, a SON, an OAM, a core network element (for example, an NWDAF or a newly defined network element responsible for decision-making), network management, or the like. The third device may be configured for AI service decision-making, for example, for defining a training framework, configuring a hyperparameter, or selecting a basic model. The third device may be a base station, a SON, an OAM, a core network element (for example, an NWDAF or a newly defined network element responsible for decision-making), network management, or the like.

In this implementation, the first device receives the first boundary parameter and the second boundary parameter sent by the third device, and the first device receives the training process parameter and the AI model attribute information sent by the second device. In this way, the first device can obtain the first boundary parameter and the second boundary parameter from an AI service decision device, and obtain the training process parameter and the AI model attribute information from an AI training device.

In some embodiments, the determining, by the first device based on an inference result of a target inference model and the time-varying parameter information, a training sample used for training the target inference model includes:
determining, by the first device, a time-varying greedy parameter based on the first boundary parameter, the second boundary parameter, and the training process parameter; and
determining, by the first device based on the inference result of the target inference model and the time-varying greedy parameter, the training sample used for training the target inference model.

In this implementation, the first device determines a time-varying greedy parameter based on the first boundary parameter, the second boundary parameter, and the training process parameter; and the first device determines, based on the inference result of the target inference model and the time-varying greedy parameter, the training sample used for training the target inference model. In this way, the time-varying greedy parameter is determined through the interaction between the first device and the second device and the interaction between the first device and the third device, and the training sample used for training the target inference model is obtained on the first device. In this way, the target inference model can be trained by using a network environment of the first device, so that reinforcement learning training of the target inference model can be implemented.

In some embodiments, the determining, by the first device, a time-varying greedy parameter based on the first boundary parameter, the second boundary parameter, and the training process parameter includes:
determining, by the first device, a training progress parameter based on the second boundary parameter and the training process parameter; and
determining, by the first device, the time-varying greedy parameter based on the training progress parameter and the first boundary parameter.

In a specific implementation, the first boundary parameter may include a start boundary and an end boundary of the time-varying greedy parameter. The second boundary parameter may include a start and an end of a time-varying greedy strategy enabling training process. Assuming that a training step is used to represent a training process, the start of the time-varying greedy strategy enabling training process is a start step of a training process when a time-varying greedy strategy is enabled, and the end of the time-varying greedy strategy enabling training process is an end step of the training process when the time-varying greedy strategy is enabled. The training process parameter is a real-time training step.

A process of determining the time-varying greedy parameter based on the first boundary parameter, the second boundary parameter, and the training process parameter may be as follows:

(1): Calculate a training progress parameter through the real-time training step, the start step of the training process when the time-varying greedy strategy is enabled, and the end step of the training process when the time-varying greedy strategy is enabled. The training progress parameter may be used for representing a real-time training progress. The training progress parameter is represented as a ratio between 0 and 1.

For example:

Training progress parameter=(Real-time step-Start step of training process when time-varying greedy strategy is enabled)/(End step of training process when time-varying greedy strategy is enabled-Start step of training process when time-varying greedy strategy is enabled)

(2): Obtain a real-time time-varying greedy parameter based on the training progress parameter and the start boundary and the end boundary of the time-varying greedy parameter. For example:

Time-varying greedy parameter=Start boundary of time-varying greedy parameter+Training progress parameter*(End boundary of time-varying greedy parameter−Start boundary of time-varying greedy parameter)

In some embodiments, the determining, by the first device based on an inference result of a target inference model and the time-varying parameter information, a training sample used for training the target inference model includes:
determining, by the first device, a target communication behavior based on the inference result of the target inference model and the time-varying parameter information.

The training sample includes the target communication behavior.

In an implementation, the time-varying parameter information is used for determining a time-varying greedy parameter, and the determining, by the first device, a target communication behavior based on the inference result of the target inference model and the time-varying parameter information may include: generating a random number; determining, in a case that the generated random number is less than the time-varying greedy parameter, that the target communication behavior is a communication behavior corresponding to the inference result of the target inference model; and/or determining, in a case that the generated random number is greater than or equal to the time-varying greedy parameter, that the target communication behavior is a communication behavior randomly selected from a pre-defined communication behavior set.

The target communication behavior may be represented by an action. The target communication behavior may be a first action. The inference result of the target inference model may be an AI inference result. That the target communication behavior is a communication behavior corresponding to the inference result of the target inference model may be understood as a case that the first action is the AI inference result. The pre-defined communication behavior set may be a pre-defined action set.

In addition, the pre-defined communication behavior set may be at least one of the following:
a set of transmit and receive beam combinations of channel quality;
a set of transmit beams reporting channel quality;
a set of Modulation and coding scheme (MCS);
a set of paired user groups; or
a set of paired beams.

For example, a process of determining the target communication behavior based on the inference result and the time-varying parameter information may be as follows:

(1): Generate a random number x uniformly distributed between 0 and 1.

(2): Determine whether the random number x is less than the time-varying greedy parameter. If the random number x is less than the time-varying greedy parameter, the first action is the AI inference result. If the random number x is greater than or equal to the time-varying greedy parameter, the first action is an action randomly selected according to a uniform distribution in the pre-defined action set.

In this implementation, the first device determines the target communication behavior based on the inference result of the target inference model and the time-varying parameter information, so that the target communication behavior can be obtained by using a network environment of the first device, and the training sample is determined based on the target communication behavior.

In some embodiments, the target communication behavior includes at least one of the following:
predicting a transmit and receive beam combination with highest channel quality;
reporting a transmit beam with highest channel quality;
selecting a modulation and coding scheme MCS;
selecting a paired user group; or
selecting paired beams.

It should be noted that the target communication behavior may include predicting a transmit and receive beam combination with highest channel quality, so that the first device can predict, based on the target inference model and the time-varying parameter information, the transmit and receive beam combination with the highest channel quality. The target communication behavior may include reporting a transmit beam with highest channel quality, so that the first device can report the transmit beam with the highest channel quality based on the target inference model and the time-varying parameter information. The target communication behavior may include selecting an MCS, so that the first device can select the MCS based on the target inference model and the time-varying parameter information. The target communication behavior may include selecting a paired user group, so that the first device can select the paired user group based on the target inference model and the time-varying parameter information. The target communication behavior may include selecting paired beams, so that the first device can select the paired beams based on the target inference model and the time-varying parameter information.

In some embodiments, before the determining, by the first device, a target communication behavior based on the inference result of the target inference model and the time-varying parameter information, the method further includes:
inputting, by the first device, historical state information into the target inference model to obtain the inference result.

The training sample further includes the historical state information.

The historical state information is an input of the target inference model.

In an implementation, the historical state information may include at least one of the following:
channel quality of a historical multi-dimensional transmit and receive beam
a historical bit error rate;
a historical selected MCS;
a historical throughput;
a historical selected paired user group; or
historical selected paired beams.

In this implementation, the first device inputs the historical state information into the target inference model to obtain the inference result. The first device determines the target communication behavior based on the inference result of the target inference model and the time-varying parameter information. In this way, the target communication behavior can be obtained by using the historical state information of the first device, and the training sample is determined based on the target communication behavior.

In some embodiments, after the determining a target communication behavior, the method further includes:
executing, by the first device, the target communication behavior; and
determining, by the first device, a target reward and updated state information that correspond to the target communication behavior, where the target reward is used for indicating network performance.

The training sample further includes the target reward and the updated state information.

In an implementation, after performing the target communication behavior, the first device may observe a target reward and updated state information that are obtained after executing the target communication behavior. The target reward may be used for indicating a change in network performance obtained after the first device executes the target communication behavior.

In addition, the updated state information may have the same attribute and format as the historical state information. The updated state information is state information observed after the first device executes the target communication behavior. The state information may be used for representing a state of a network environment of the first device.

In an implementation, the updated state information may include at least one of the following:
updated channel quality of a multi-dimensional transmit and receive beam
an updated bit error rate;
an updated selected MCS;
an updated throughput;
an updated selected paired user group; or
updated selected paired beams.

In this implementation, the first device executes the target communication behavior, and the first device determines the target reward and the updated state information that correspond to the target communication behavior, so that the training sample can be determined by using feedbacks of the first device on the target communication behavior, thereby implementing reinforcement learning training of the target inference model.

In some embodiments, the state information includes at least one of the following:
channel quality of a multi-dimensional transmit and receive beam combination;
a bit error rate;
a selected MCS;
a throughput;
a selected paired user group; or
selected paired beams.

In some embodiments, the target reward includes at least one of the following:
channel quality of a serving beam;
a user throughput;
a cell throughput;
channel quality of a Physical Downlink Shared Channel (PDSCH); or
channel quality difference information, where the channel quality difference information is used for indicating a difference between actual channel quality of a transmit and receive beam combination with highest predicted quality and highest channel quality of the transmit and receive beam combination actually measured.

In some embodiments, after the determining a training sample used for training the target inference model, the method further includes:
sending, by the first device, the training sample to the target device.

In an implementation, the training sample includes: the historical state information, the target communication behavior, the target reward, and the updated state information.

In an implementation, the first device stores the historical state information, the target communication behavior, the target reward, and the updated state information as a set of training samples.

In an implementation, the first device sends a stored training sample to the target device.

In an implementation, the target device includes a second device, and the first device sends a stored training sample to the second device.

In an implementation, the historical state information may be represented as a first state, the target communication behavior may be represented as a first action, the target reward may be represented as a first reward, and the updated state information may be represented as a second state.

The second device may train the target inference model based on the training sample. Using a DQN as an example, in a training process, the target inference model includes a first neural network and a second neural network. Each training sample includes a first state, a first action, a first reward, and a second state. Training parameters include: an attenuation coefficient and an iteration interval.

That the target inference model is trained by using one training sample is used as an example, a process of training the target inference model based on the training sample may be as follows:

(1): Input the first state into the first neural network to obtain a first value vector of each action.

(2): Find a value corresponding to the first action from the first value vector to obtain a first long-term value.

(3): Input the second state into the second neural network to obtain a second value vector of each action.

(4): Multiply a maximum value of the second value vector by the attenuation coefficient to obtain a product, and add the product and the first reward to obtain a second long-term reward.

(5): Use a difference between the first long-term reward and the second long-term reward as a variable for backpropagation of the first neural network.

At each iteration interval, the first neural network is assigned to the second neural network.

In this implementation, the first device sends the training sample to the target device, so that the target device can train the target inference model based on the training sample, and can train the target inference model by using a network environment of the first device, thereby implementing reinforcement learning training of the target inference model.

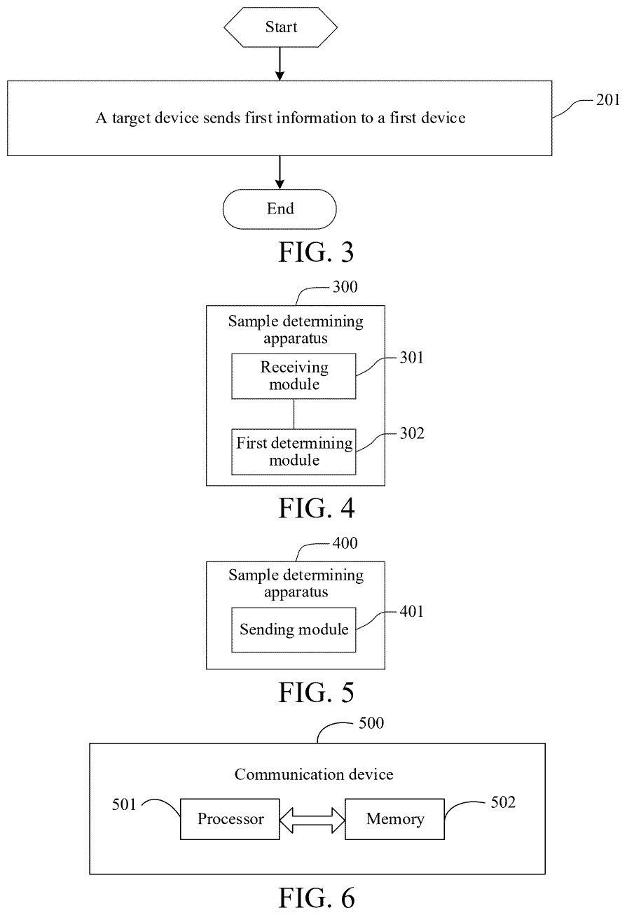

FIG. 3 is a flowchart of a sample determining method according to an embodiment of this application. As shown in FIG. 3, the sample determining method includes the following steps:

Step 201: A target device sends first information to a first device, where the first information includes time-varying parameter information and AI model attribute information, and the time-varying parameter information is used for indicating randomness of a communication behavior.

The time-varying parameter information and the AI model attribute information are used for determining a training sample. The training sample is used for training a target inference model. The target inference model is an inference model corresponding to the AI model attribute information.

In some embodiments, after the sending, by a target device, first information to a first device, the method further includes:
receiving, by the target device, the training sample sent by the first device; and
training, by the target device, the target inference model based on the training sample.

It should be noted that this embodiment serves as an implementation of a corresponding target device in the embodiment shown in FIG. 2. For a specific implementation of this embodiment, refer to related descriptions in the embodiment shown in FIG. 2. To avoid repeated descriptions, details are not described again in this embodiment. In this way, the time-varying parameter information and the AI model attribute information are obtained through the interaction between the first device and the target device, and the training sample used for training the target inference model is obtained on the first device. In this way, the target inference model can be trained by using a network environment of the first device, so that reinforcement learning training of the target inference model can be implemented.

The sample determining method provided in this embodiment of this application may be performed by a sample determining apparatus. In the embodiments of this application, an example in which the sample determining apparatus performs the sample determining method is used to describe the sample determining apparatus provided in the embodiments of this application.

FIG. 4 is a structural diagram of a sample determining apparatus according to an embodiment of this application. A first device includes the sample determining apparatus. As shown in FIG. 4, the sample determining apparatus 300 includes:
a receiving module 301, configured to receive first information sent by a target device, where the first information includes time-varying parameter information and artificial intelligence AI model attribute information, and the time-varying parameter information is used for indicating randomness of a communication behavior; and
a first determining module 302, configured to determine, based on an inference result of a target inference model and the time-varying parameter information, a training sample used for training the target inference model, where the target inference model is an inference model corresponding to the AI model attribute information.

In some embodiments, the time-varying parameter information includes a time-varying greedy parameter.

In some embodiments, the time-varying parameter information includes a first boundary parameter, a second boundary parameter, and a training process parameter. The first boundary parameter is used for indicating a start boundary and an end boundary of a time-varying greedy parameter. The second boundary parameter is used for indicating start information and end information of a time-varying greedy strategy enabling training process.

In some embodiments, the target device includes a second device and a third device, and the receiving module is configured to:
receive the first boundary parameter and the second boundary parameter sent by the third device; and
receive the training process parameter and the AI model attribute information sent by the second device.

In some embodiments, the first determining module includes:
a first determining unit, configured to determine a time-varying greedy parameter based on the first boundary parameter, the second boundary parameter, and the training process parameter; and
a second determination unit, configured to determine, based on the inference result of the target inference model and the time-varying greedy parameter, the training sample used for training the target inference model.

In some embodiments, the first determining unit is configured to:
determine a training progress parameter based on the second boundary parameter and the training process parameter; and
determine the time-varying greedy parameter based on the training progress parameter and the first boundary parameter.

In some embodiments, the first determining module is configured to:
determine a target communication behavior based on the inference result of the target inference model and the time-varying parameter information.

The training sample includes the target communication behavior.

In some embodiments, the target communication behavior includes at least one of the following:
predicting a transmit and receive beam combination with highest channel quality;
reporting a transmit beam with highest channel quality;
selecting a modulation and coding scheme MCS;
selecting a paired user combination; or
selecting paired beams.

In some embodiments, the apparatus further includes:
an input module, configured to input historical state information into the target inference model to obtain the inference result.

The training sample further includes the historical state information.

In some embodiments, the apparatus further includes:
an execution module, configured to execute the target communication behavior; and
a second determining module, configured to determine a target reward and updated state information that correspond to the target communication behavior, where the target reward is used for indicating network performance.

The training sample further includes the target reward and the updated state information.

In some embodiments, the state information includes at least one of the following:
channel quality of a multi-dimensional transmit and receive beam combination;
a bit error rate;
a selected MCS;
a throughput;
a selected paired user combination; or
selected paired beams.

In some embodiments, the target reward includes at least one of the following:
channel quality of a serving beam;
a user throughput;
a cell throughput;
channel quality of a physical downlink shared channel PDSCH; or
channel quality difference information, where the channel quality difference information is used for indicating a difference between actual channel quality of a transmit and receive beam combination with highest predicted quality and highest channel quality of the transmit and receive beam combination actually measured.

In some embodiments, the apparatus further includes:
a sending module, configured to send the training sample to the target device.

In the sample determining apparatus in this embodiment of this application, the time-varying parameter information and the AI model attribute information are obtained through the interaction between the first device and the target device, and the training sample used for training the target inference model is obtained on the first device. In this way, the target inference model can be trained by using a network environment of the first device, so that reinforcement learning training of the target inference model can be implemented.

The sample determining apparatus in this embodiment of this application may be an electronic device, for example, an electronic device having an operating system, or may be a component in the electronic device, for example, an integrated circuit or a chip. The electronic device may be a terminal or a device other than the terminal. For example, the terminal may include, but is not limited to, the types of the terminal 11 listed above. The another device may be a server, a Network Attached Storage (NAS), or the like. This is not specifically limited in this embodiment of this application.

The sample determining apparatus provided in this embodiment of this application can implement the processes implemented in the method embodiment of FIG. 2 and achieve the same technical effect. To avoid repetition, details are not described herein again.

FIG. 5 is a structural diagram of a sample determining apparatus according to an embodiment of this application. A target device includes the sample determining apparatus. As shown in FIG. 5, the sample determining apparatus 400 includes:
a sending module 401, configured to send first information to a first device, where the first information includes time-varying parameter information and AI model attribute information, and the time-varying parameter information is used for indicating randomness of a communication behavior.

The time-varying parameter information and the AI model attribute information are used for determining a training sample, the training sample is used for training a target inference model, and the target inference model is an inference model corresponding to the AI model attribute information.

In some embodiments, the apparatus further includes:
a receiving module, configured to receive the training sample sent by the first device; and
a training module, configured to train the target inference model based on the training sample.

In the sample determining apparatus in this embodiment of this application, the time-varying parameter information and the AI model attribute information are obtained through the interaction between the first device and the target device, and the training sample used for training the target inference model is obtained on the first device. In this way, the target inference model can be trained by using a network environment of the first device, so that reinforcement learning training of the target inference model can be implemented.

The sample determining apparatus in this embodiment of this application may be an electronic device, for example, an electronic device having an operating system, or may be a component in the electronic device, for example, an integrated circuit or a chip. The electronic device may be a terminal or a device other than the terminal. For example, the terminal may include, but is not limited to, the types of the terminal 11 listed above. The another device may be a server, a NAS, or the like. This is not specifically limited in this embodiment of this application.

The sample determining apparatus provided in this embodiment of this application can implement the processes implemented in the method embodiment of FIG. 3 and achieve the same technical effect. To avoid repetition, details are not described herein again.

In some embodiments, as shown in FIG. 6, an embodiment of this application further provides a communication device 500, including a processor 501 and a memory 502. The memory 502 stores a program or an instruction runnable on the processor 501. For example, when the communication device 500 is a first device, the program or the instruction, when executed by the processor 501, implements the steps of the foregoing sample determining method embodiment applied to the first device, and the same technical effect can be achieved. When the communication device 500 is a target device, the program or the instruction, when executed by the processor 501, implements the steps of the foregoing the sample determining method embodiment applied to the target device, and the same technical effect can be achieved. To avoid repetition, details are not described herein again.

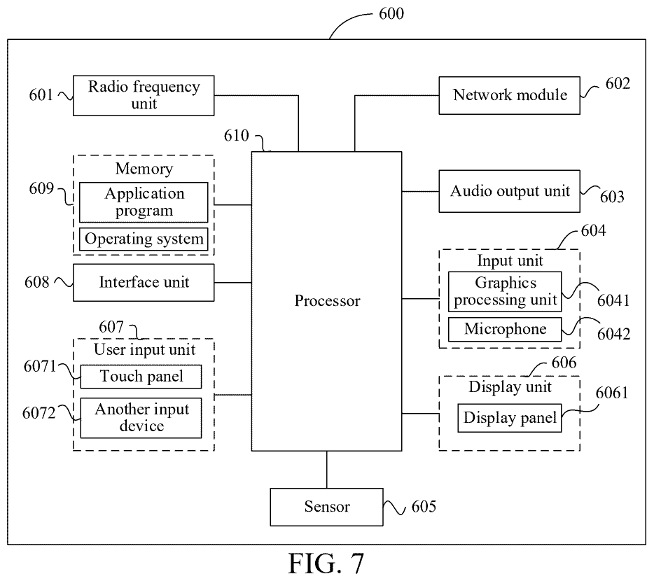

An embodiment of this application further provides a terminal. The terminal may be a first device, and includes a processor and a communication interface. The communication interface is configured to receive first information sent by a target device. The first information includes time-varying parameter information and artificial intelligence AI model attribute information. The time-varying parameter information is used for indicating randomness of a communication behavior. The processor is configured to determine, based on an inference result of a target inference model and the time-varying parameter information, a training sample used for training the target inference model. The target inference model is an inference model corresponding to the AI model attribute information. This terminal embodiment corresponds to the foregoing first device side method embodiment. Implementation processes and implementations of the foregoing method embodiment all may be applied to this terminal embodiment, and the same technical effect can be achieved. Specifically, FIG. 7 is a schematic diagram of a hardware structure of a terminal that implements the embodiments of this application.

The terminal 600 includes, but is not limited to: at least some components in a radio frequency unit 601, a network module 602, an audio output unit 603, an input unit 604, a sensor 605, a display unit 606, a user input unit 607, an interface unit 608, a memory 609, and a processor 610.

A person skilled in the art may understand that, the terminal 600 may further include a power supply (such as a battery) for supplying power to each component. The power supply may be logically connected to the processor 610 by using a power management system, thereby implementing functions, such as charging, discharging, and power consumption management, by using the power management system. The terminal structure shown in FIG. 7 constitutes no limitation on the terminal, and the terminal may include more or fewer components than those shown in the figure, or some components may be combined, or a different component deployment may be used. Details are not described herein.

It should be understood that in this embodiment of this application, the input unit 604 may include a Graphics Processing Unit (GPU) 6041 and a microphone 6042. The graphics processing unit 6041 processes image data of still pictures or videos captured by an image capture apparatus (such as a camera) in a video capture mode or an image capture mode. The display unit 606 may include a display panel 6061. The display panel 6061 may be configured in a form of a liquid crystal display, an organic light-emitting diode, or the like. The user input unit 607 includes at least one of a touch panel 6071 and another input device 6072. The touch panel 6071 is also referred to as a touchscreen. The touch panel 6071 may include two parts: a touch detection apparatus and a touch controller. The another input device 6072 may include, but is not limited to, a physical keyboard, a functional button (such as a sound volume control button or a power button), a trackball, a mouse, or a joystick. Details are not described herein.

In this embodiment of this application, after receiving downlink data from a network side device, the radio frequency unit 601 may transmit the downlink data to the processor 610 for processing. In addition, the radio frequency unit 601 may send uplink data to the network side device. Usually, the radio frequency unit 601 includes, but is not limited to, an antenna, an amplifier, a transceiver, a coupler, a low noise amplifier, a duplexer, and the like.

The memory 609 may be configured to store a software program or instruction and various data. The memory 609 may mainly include a first storage area storing a program or an instruction and a second storage area storing data. The first storage area may store an operating system, an application program or an instruction required by at least one function (for example, a sound playing function or an image playing function), and the like. In addition, the memory 609 may include a volatile memory or a non-volatile memory, or the memory 609 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 609 in this embodiment of this application includes, but is not limited to, these memories and any other suitable types of memories.

The processor 610 may include one or more processing units. In some embodiments, the processor 610 integrates an application processor and a modem processor. The application processor mainly processes operations related to the operating system, a user interface, the application program, and the like. The modem processor mainly processes a wireless communication signal, and is, for example, a baseband processor. It may be understood that, the modem processor may not be integrated in the processor 610.

The terminal may be a first device:

The radio frequency unit 601 is further configured to: receive first information sent by a target device, where the first information includes time-varying parameter information and artificial intelligence AI model attribute information, and the time-varying parameter information is used for indicating randomness of a communication behavior.

The processor 610 is further configured to: determine, based on an inference result of a target inference model and the time-varying parameter information, a training sample used for training the target inference model. The target inference model is an inference model corresponding to the AI model attribute information.

In some embodiments, the time-varying parameter information includes a time-varying greedy parameter.

In some embodiments, the time-varying parameter information includes a first boundary parameter, a second boundary parameter, and a training process parameter. The first boundary parameter is used for indicating a start boundary and an end boundary of a time-varying greedy parameter. The second boundary parameter is used for indicating start information and end information of a time-varying greedy strategy enabling training process.

In some embodiments, the target device includes a second device and a third device. The processor 610 is further configured to:
receive the first boundary parameter and the second boundary parameter sent by the third device; and
receive the training process parameter and the AI model attribute information sent by the second device.

In some embodiments, the processor 610 is further configured to:
determine a time-varying greedy parameter based on the first boundary parameter, the second boundary parameter, and the training process parameter; and
determine, based on the inference result of the target inference model and the time-varying greedy parameter, the training sample used for training the target inference model.

In some embodiments, the processor 610 is further configured to:
determine a training progress parameter based on the second boundary parameter and the training process parameter; and
determine a time-varying greedy parameter based on the training progress parameter and the first boundary parameter.

In some embodiments, the processor 610 is further configured to: determine a target communication behavior based on the inference result of the target inference model and the time-varying parameter information. The training sample includes the target communication behavior.

In some embodiments, the target communication behavior includes at least one of the following:
predicting a transmit and receive beam combination with highest channel quality;
reporting a transmit beam with highest channel quality;
selecting a modulation and coding scheme MCS;
selecting a paired user combination; or
selecting paired beams.

In some embodiments, the processor 610 is further configured to: input historical state information into the target inference model to obtain the inference result. The training sample further includes the historical state information.

In some embodiments, the processor 610 is further configured to:
execute the target communication behavior; and
determine a target reward and updated state information that correspond to the target communication behavior, where the target reward is used for indicating network performance.

The training sample further includes the target reward and the updated state information.

In some embodiments, the state information includes at least one of the following:
channel quality of a multi-dimensional transmit and receive beam combination;
a bit error rate;
a selected MCS;
a throughput;
a selected paired user combination; or
selected paired beams.

In some embodiments, the target reward includes at least one of the following:
channel quality of a serving beam;
a user throughput;
a cell throughput;
channel quality of a physical downlink shared channel PDSCH; or
channel quality difference information, where the channel quality difference information is used for indicating a difference between actual channel quality of a transmit and receive beam combination with highest predicted quality and highest channel quality of the transmit and receive beam combination actually measured.

In some embodiments, the processor 610 is further configured to:
send the training sample to the target device.

In this implementation, the time-varying parameter information and the AI model attribute information are obtained through the interaction between the first device and the target device, and the training sample used for training the target inference model is obtained on the first device. In this way, the target inference model can be trained by using a network environment of the first device, so that reinforcement learning training of the target inference model can be implemented.

An embodiment of this application further provides a network side device, including a processor and a communication interface. The communication interface is configured to receive first information sent by a target device. The first information includes time-varying parameter information and artificial intelligence AI model attribute information. The time-varying parameter information is used for indicating randomness of a communication behavior. The processor is configured to determine, based on an inference result of a target inference model and the time-varying parameter information, a training sample used for training the target inference model. The target inference model is an inference model corresponding to the AI model attribute information. Alternatively, the communication interface is configured to send first information to a first device. The first information includes time-varying parameter information and AI model attribute information. The time-varying parameter information is used for indicating randomness of a communication behavior. The time-varying parameter information and the AI model attribute information are used for determining a training sample. The training sample is used for training a target inference model. The target inference model is an inference model corresponding to the AI model attribute information. The network side device embodiment corresponds to the foregoing first device side method embodiment or the foregoing target device side method embodiment. Implementation processes and implementations of the foregoing method embodiment all may be applied to the network side device embodiment, and the same technical effect can be achieved.

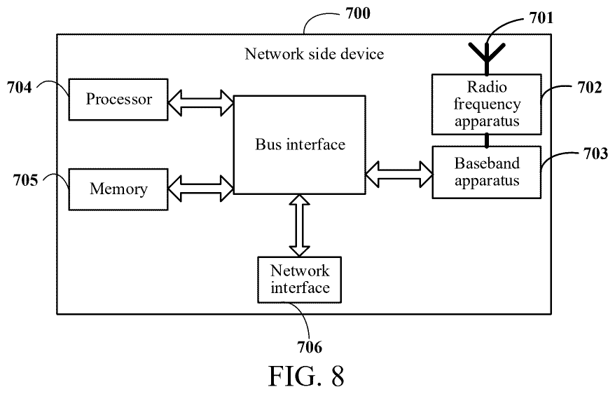

Specifically, an embodiment of this application further provides a network side device. As shown in FIG. 8, the network side device 700 includes: an antenna 701, a radio frequency apparatus 702, a baseband apparatus 703, a processor 704, and a memory 705. The antenna 701 is connected to the radio frequency apparatus 702. In an uplink direction, the radio frequency apparatus 702 receives information through the antenna 701, and sends the received information to the baseband apparatus 703 for processing. In a downlink direction, the baseband apparatus 703 processes and sends to-be-sent information to the radio frequency apparatus 702. The radio frequency apparatus 702 processes received information and sends the information through the antenna 701.

The method performed by the network side device in the foregoing embodiment may be implemented in the baseband apparatus 703. The baseband apparatus 703 includes a baseband processor.

The baseband apparatus 703 may include, for example, at least one baseband board. A plurality of chips are disposed on the baseband board. One chip is, for example, the baseband processor, and is connected to the memory 705 through a bus interface, to call a program in the memory 705 to perform the operations of the network side device shown in the foregoing method embodiment.

The network side device may further include a network interface 706. The interface is, for example, a Common Public Radio Interface (CPRI).

Specifically, the network side device 700 of this embodiment of this application further includes: an instruction or a program stored in the memory 705 and runnable on the processor 704. The processor 704 calls the instruction or the program in the memory 705 to perform the method performed by each module shown in FIG. 4 or FIG. 5, and the same technical effect is achieved. To avoid repetition, details are not described herein again.

An embodiment of this application further provides a readable storage medium, storing a program or an instruction. The program or the instruction, when executed by a processor, implements the processes of the foregoing sample determining method embodiment, and the same technical effect can be achieved. To avoid repetition, details are not described herein again.

The processor is the processor in the terminal described in the foregoing embodiment. The readable storage medium includes a computer-readable storage medium, such as a computer read-only memory ROM, a random access memory RAM, a magnetic disk, or an optical disc.

An embodiment of this application further provides a chip, including a processor and a communication interface. The communication interface is coupled to the processor. The processor is configured to run a program or an instruction to implement the processes of the foregoing sample determining method embodiment, and the same technical effect can be achieved. To avoid repetition, details are not described herein again.

It should be understood that, the chip mentioned in this embodiment of this application may also be referred to as a system on a chip, a system chip, a chip system, a system-on-chip, or the like.

An embodiment of this application further provides a computer program/program product. The computer program/program product is stored in a storage medium. The computer program/program product is executed by at least one processor to implement the processes of the foregoing information feedback method, and the same technical effect can be achieved. To avoid repetition, details are not described herein again.

An embodiment of this application further provides a sample determining system, including: a first device and a target device. The first device may be configured to perform the steps of the sample determining method on the first device side as described above. The target device may be configured to perform the steps of the sample determining method on the target device side as described above.

It should be noted that in this specification, the term “include”, “comprise”, or any other variant thereof is intended to cover a non-exclusive inclusion, so that a process, method, article, or apparatus including a series of elements includes not only those elements, but also other elements not expressly listed, or elements inherent to such a process, method, article, or apparatus. Without more restrictions, the elements defined by the sentence “including a . . . ” do not exclude the existence of other identical elements in the process, method, article, or apparatus including the elements. In addition, it should be noted that, the scope of the methods and apparatuses in the implementations of this application is not limited to performing the functions in the order shown or discussed, but may further include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

According to the descriptions in the foregoing implementations, a person skilled in the art may clearly learn that the method according to the foregoing embodiment may be implemented by means of software plus a necessary universal hardware platform, or by using hardware. However, in many cases, the former is a preferred implementation. Based on such an understanding, the technical solutions of this application essentially, or a part contributing to the related art, may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods according to the embodiments of this application.

The embodiments of this application have been described above with reference to the accompanying drawings, but this application is not limited to the foregoing specific implementations. The foregoing specific implementations are only illustrative instead of restrictive. Under the inspiration of this application, without departing from the purpose of this application and the scope of protection of the claims, a person of ordinary skill in the art can still make many forms, which all fall within the protection of this application.

What is claimed is:

1. A sample determining method, comprising:
receiving, by a first device, first information sent by a target device, wherein the first information comprises time-varying parameter information and Artificial Intelligence (AI) model attribute information, and the time-varying parameter information is used for indicating randomness of a communication behavior; and
determining, by the first device based on an inference result of a target inference model and the time-varying parameter information, a training sample used for training the target inference model, wherein the target inference model is an inference model corresponding to the AI model attribute information.

2. The method according to claim 1, wherein the time-varying parameter information comprises a time-varying greedy parameter.

3. The method according to claim 1, wherein the time-varying parameter information comprises a first boundary parameter, a second boundary parameter, and a training process parameter, wherein the first boundary parameter is used for indicating a start boundary and an end boundary of a time-varying greedy parameter, and the second boundary parameter is used for indicating start information and end information of a time-varying greedy strategy enabling training process.

4. The method according to claim 3, wherein the target device comprises a second device and a third device, and the receiving, by the first device, the first information sent by the target device comprises:
receiving, by the first device, the first boundary parameter and the second boundary parameter sent by the third device; and
receiving, by the first device, the training process parameter and AI model attribute information sent by the second device.

5. The method according to claim 3, wherein the determining, by the first device based on the inference result of the target inference model and the time-varying parameter information, the training sample used for training the target inference model comprises:
determining, by the first device, a time-varying greedy parameter based on the first boundary parameter, the second boundary parameter, and the training process parameter; and
determining, by the first device based on the inference result of the target inference model and the time-varying greedy parameter, the training sample used for training the target inference model.

6. The method according to claim 5, wherein the determining, by the first device, the time-varying greedy parameter based on the first boundary parameter, the second boundary parameter, and the training process parameter comprises:
determining, by the first device, a training progress parameter based on the second boundary parameter and the training process parameter; and
determining, by the first device, the time-varying greedy parameter based on the training progress parameter and the first boundary parameter.

7. The method according to claim 1, wherein the determining, by the first device based on the inference result of the target inference model and the time-varying parameter information, the training sample used for training the target inference model comprises:
determining, by the first device, a target communication behavior based on the inference result of the target inference model and the time-varying parameter information,
wherein the training sample comprises the target communication behavior.

8. The method according to claim 7, wherein the target communication behavior comprises at least one of the following:
predicting a transmit and receive beam combination with highest channel quality;
reporting a transmit beam with highest channel quality;
selecting a modulation and coding scheme MCS;
selecting a paired user group; or
selecting paired beams.

9. The method according to claim 7, wherein before the determining, by the first device, the target communication behavior based on the inference result of the target inference model and the time-varying parameter information, the method further comprises:
inputting, by the first device, historical state information into the target inference model to obtain the inference result,
wherein the training sample further comprises the historical state information.

10. The method according to claim 7, wherein after the determining the target communication behavior, the method further comprises:
executing, by the first device, the target communication behavior; and
determining, by the first device, a target reward and updated state information that correspond to the target communication behavior, wherein the target reward is used for indicating network performance,
wherein the training sample further comprises the target reward and the updated state information.

11. The method according to claim 9, wherein the state information comprises at least one of the following:
channel quality of a multi-dimensional transmit and receive beam combination;
a bit error rate;
a selected MCS;
a throughput;
a selected paired user combination; or
selected paired beams.

12. The method according to claim 10, wherein the target reward comprises at least one of the following:
channel quality of a serving beam;
a user throughput;
a cell throughput;
channel quality of a physical downlink shared channel PDSCH; or
channel quality difference information, wherein the channel quality difference information is used for indicating a difference between actual channel quality of a transmit and receive beam combination with highest predicted quality and highest channel quality of the transmit and receive beam combination actually measured.

13. The method according to claim 1, wherein after the determining the training sample used for training the target inference model, the method further comprises:
sending, by the first device, the training sample to the target device.

14. A sample determining method, comprising:
sending, by a target device, first information to a first device, wherein the first information comprises time-varying parameter information and AI model attribute information, and the time-varying parameter information is used for indicating randomness of a communication behavior,
wherein the time-varying parameter information and the AI model attribute information are used for determining a training sample, the training sample is used for training a target inference model, and the target inference model is an inference model corresponding to the AI model attribute information.

15. The method according to claim 14, wherein after the sending, by the target device, the first information to the first device, the method further comprises:
receiving, by the target device, the training sample sent by the first device; and
training, by the target device, the target inference model based on the training sample.

16. An electronic device, wherein the electronic device is a first device and comprises a processor and a memory storing instructions, wherein the instructions, when executed by the processor, cause the processor to perform operations comprising:
receiving first information sent by a target device, wherein the first information comprises time-varying parameter information and Artificial Intelligence (AI) model attribute information, and the time-varying parameter information is used for indicating randomness of a communication behavior; and
determining a training sample used for training the target inference model based on an inference result of a target inference model and the time-varying parameter information, wherein the target inference model is an inference model corresponding to the AI model attribute information.

17. The electronic device according to claim 16, wherein the time-varying parameter information comprises a time-varying greedy parameter.

18. The electronic device according to claim 16, wherein the time-varying parameter information comprises a first boundary parameter, a second boundary parameter, and a training process parameter, the first boundary parameter is used for indicating a start boundary and an end boundary of a time-varying greedy parameter, and the second boundary parameter is used for indicating start information and end information of a time-varying greedy strategy enabling training process

19. The electronic device according to claim 18, wherein the target device comprises a second device and a third device, and the receiving the first information sent by the target device comprises:
receiving the first boundary parameter and the second boundary parameter sent by the third device; and
receiving the training process parameter and AI model attribute information sent by the second device.

20. The electronic device according to claim 18, wherein the determining the training sample used for training the target inference model based on the inference result of the target inference model and the time-varying parameter information, comprises:
determining a time-varying greedy parameter based on the first boundary parameter, the second boundary parameter, and the training process parameter; and
determining the training sample used for training the target inference model based on the inference result of the target inference model and the time-varying greedy parameter.
